(19) United States
(12) Patent Application Publication
(10) Pub. No.: US 2021/0319807 A1
(43) Pub. Date: Oct. 14, 2021

(54) ROTARY CAGE TYPE OPTICAL DISK LIBRARY STORAGE SYSTEM CAPABLE OF REPLACING OPTICAL DISKS

(71) Applicant: Beijing Zhongke Kaidi Software Co. LTD, Beijing (CN)

(72) Inventors: Li ZHANG, Beijing (CN); Meng NING, Beijing (CN); Ziqiang ZHANG, Beijing (CN); Weixi YOU, Beijing (CN); Shijie BAI, Beijing (CN)

(21) Appl. No.: 17/035,695

(22) Filed: Sep. 29, 2020

(30) Foreign Application Priority Data
Apr. 13, 2020 (CN) 202010286110.4

(51) Int. Cl. G11B 17/028; G11B 33/04; G11B 7/0045; G11B 17/035; G11B 17/049; B65G 1/04

(52) U.S. Cl. CPC G11B 17/0286; G11B 33/0466; B65G 1/045; G11B 17/035; G11B 17/049; G11B 7/0045

(57) ABSTRACT

Disclosed is a rotary cage type optical disk library storage system capable of replacing optical disks. The device includes a case, a burning device, and a rotary cage storage device. The burning device is fixed in the case and includes a burn cabinet, a disk feeding mechanism and an internal gripping mechanism. Multiple optical disk cartridges are arranged in layers from top to bottom in the burning cabinet. The disk feeding mechanism is located just below the burning cabinet. The internal gripping mechanism can move up and down and grab and place the optical disk. The rotary cage storage device and the burning device are fixed in the case side by side. The rotary cage storage device includes a rotary cage mechanism, a rotary cage cassette placed in the rotary cage mechanism for storing optical disks, and a belt drive mechanism driving the rotary cage mechanism to rotate.

### CROSS-REFERENCE TO RELATED APPLICATIONS

The application claims priority to Chinese patent application No. 202010286110.4, filed on Apr. 13, 2020, the entire contents of which are incorporated herein by reference.

### TECHNICAL FIELD

The disclosure relates to the technical field of large capacity optical storage devices, and more specifically, to a rotary cage type optical disk library storage system capable of replacing optical disks.

### BACKGROUND

Optical storage is a mass data storage method that uses optical disks as storage medium with the advantages of low energy consumption, mobility, and long data storage period. It is very suitable for storing data with low access frequency and long-term storage.

In the existing storage technology, magnetic storage hard disks, semiconductor storage U disks (including SD cards), and optical storage optical disks coexist. However, for magnetic storage, the same as semiconductor storage, the information will disappear encountering a strong electromagnetic field, and the information can be rewritten at any time; only optical storage can be read-only and cannot be rewritten after once write. Therefore, optical storage is the safest. At present, optical disks have become an indispensable information carrier medium in today's information society.

The basic function of the rotary cage optical disk library is to realize the access, reading and writing of the disks in the rotary cage optical disk library. However, the current rotary cage optical disk library still has problems such as unreasonable layout, insufficient positioning accuracy, and slow response speed. In addition, the stability of each mechanism needs to be further improved.

Therefore, there is an urgent need in the market for a rotary cage optical disk library storage system with precise action, compact structure, rapid reading and writing, and high degree of automation.

### SUMMARY

For this reason, the purpose of the present invention is to provide a rotary cage type optical disk library storage system capable of replacing optical disks. The specific technical solutions are as follows.

A rotary cage type optical disk library storage system capable of replacing optical disks is provided. The storage system includes a case, a burning device and a rotary cage storage device. The burning device is fixed in the case and includes a burn cabinet, disk feeding mechanism, and internal gripping mechanism. Multiple optical disk cartridges are arranged in layers from top to bottom in the burning cabinet. The optical disk cartridges can be automatically ejected and rebounded, and the optical disk cartridges are located just below the internal gripping mechanism after ejecting. The disk feeding mechanism located just below the burning cabinet includes a chute provided at the bottom of the case and the optical disk tray slidably connected to the chute. The optical disk is placed in the optical disk tray. The optical disk tray can slide directly below the internal gripping mechanism under pushing. The internal gripping mechanism can move up and down and grab and place the optical disk.

The rotary cage storage device and the burning device are fixed in the case side by side. The rotary cage storage device includes a rotary cage mechanism, a rotary cage cassette placed in the rotary cage mechanism for storing optical disks, and a belt drive mechanism driving the rotary cage mechanism to achieve rotation. The rotary cage cassette is installed in layers centering on the central shaft of the rotary cage mechanism. The rotary cage cassette can be rotated outward and inward relative to the rotary cage mechanism, and the rotary cage cassette is located just below the internal gripping mechanism after being rotated outward.

By adopting the above technical solution, the present invention provides a rotary cage type optical disk library storage system capable of replacing optical disks. By setting the disk feeding mechanism, the disks can be brought just below the internal gripping mechanism conveniently and accurately. It is also convenient for the removal and replacement of the optical disk. By further setting the burning cabinet, the internal gripping mechanism and the rotary cage storage device, the automatic control of the grasping, moving and placing of the optical disk is realized largely, and the purpose of the fast burning and storage of the optical disk is achieved. The structure design of the rotary cage storage device greatly increases the number of optical disks stored in a unit volume at the same time ensure its own compact structure, thereby the storage capacity of data is increased. Through the rotation of the belt drive mechanism driving the rotation of the rotary cage mechanism, the rotary cage storage device has the advantages of high stability and smooth transmission.

On the basis of the above technical solutions, the present invention can also make the following modifications:

Preferably, the bottom of the optical disk tray is provided with a sliding rail cooperating with the chute to slide.

Preferably, a screw lever is fixed in the case in vertical direction, and the top end of the screw lever is fixed with a driven wheel, and the driven wheel is connected to a driving wheel through a belt, and the driving wheel is driven to rotate by a driving wheel motor. The internal gripping mechanism is provided with a slider matched with the screw lever, and the screw lever rotates to drive the slider and the internal gripping mechanism to move up and down.

A belt drive mechanism is adopted for driving the screw lever to rotate with the advantages of high stability and smooth transmission. By converting the rotation of the screw lever into the linear motion of the internal gripping mechanism in the vertical direction, the smooth up and down movement of the internal gripping mechanism is further realized.

Preferably, the internal gripping mechanism also includes an internal gripper motor. A large gear is connected to the lower output shaft of the internal gripper motor, and the large gear is fitted and engaged with several small gears around. An optical disk clamping lever is installed at the bottom of each small gear; the inner diameter of the ring surrounded by the several optical disk clamping levers is slightly larger than the outer diameter of the optical disk. A horizontally convex optical disk baffle is provided at the lower part of the optical disk clamping lever.

Several optical disk clamping levers are the grippers of the optical disk. When a grabbing of the optical disk is needed, the optical disk clamping levers are firstly inserted around the optical disk, and then the internal gripper motor controls the rotation of the large gear, and the large gear drives several small gears to rotate, and the optical disk clamping lever on the small gears rotate accordingly. So that the optical disk baffle is screwed against the bottom surface of the optical disk and the optical disk would not fall down, thus the purpose of grabbing the optical disk is achieved. When a placing of the optical disk is desired, the optical disk clamping lever is controlled to rotate to allow the optical disk baffle rotating outward, and the optical disk falls into the corresponding position.

Preferably, the belt drive mechanism includes a belt motor, a small pulley driven to rotate by the belt motor, and a large pulley connected to the small pulley through a belt. The case is connected with a central shaft of rotary cage in the vertical direction in the case. The central shaft of rotary cage is fixed on the central axis of the rotary cage mechanism and the top end of the central shaft of rotary cage is fixed with the large pulley.

Preferably, the central shaft is connected with the case through a bearing.

Preferably, the rotary cage cassette is stacked and installed in layers with the central shaft being the center, and can realize its own rotation around the cassette positioning axis located in the rotary cage mechanism. The central shaft of rotary cage drives the rotary cage mechanism to rotate. The rotary cage mechanism can drive the rotary cage cassette inside to rotate outwards to just below the internal gripping mechanism and rotate inward.

Preferably, each rotary cage cassette is provided with a positioning piece for the rotation and positioning of the cassette. The internal gripping mechanism is provided with a rotating paddle. When the rotary cage mechanism makes a circular motion, the rotating paddle and the positioning piece can be in contact match with each other. Under the action of force, the rotating paddle drives the rotary cage cassette to rotate outward to just below the internal gripping mechanism, and the unscrewing process of the rotary cage cassette is completed. The case is also provided with a return lever. The rotary cage cassette is provided with a return gear ring. When the rotary cage mechanism rotates in a circular motion, the rotary cage cassette returns to an initial position by a relative movement between the return lever and the return gear ring.

Compared with the prior technology, the present invention of the rotary cage type optical disk library storage system capable of replacing optical disks has the advantages of precise action, compact structure, rapid reading and writing, and high degree of automation, which effectively overcomes the problems of inaccurate movement, incompact structure, slow reading and writing, and low degree of automation in the existing optical disk storage and burner.

### BRIEF DESCRIPTION OF DRAWINGS

In order to explain the embodiments of the present invention or the technical solutions in the prior art more clearly, the following will briefly introduce the drawings that need to be used in the description of the embodiments or the prior art. Obviously, the drawings in the following description are only embodiments of the present invention. For those of ordinary skill in the art, other drawings can be obtained based on the provided drawings without creative work.

FIG. 1 is the first schematic diagram of an overall structure of the present invention.

FIG. 2 is the second schematic diagram of the overall structure of the present invention.

FIG. 3 is a schematic diagram of the internal device structure of the present invention.

FIG. 4 is a schematic diagram of the structure of the burning device of the present invention.

FIG. 5 is a top view of the burning device of the present invention.

FIG. 6 is a schematic diagram of the structure of the disk feeding mechanism of the present invention.

FIG. 7 is a schematic diagram of the structure of the rotary cage storage device of the present invention.

FIG. 8 is a schematic diagram of the structure of the rotary cage cassette of the present invention.

FIG. 9 is a schematic diagram of the structure of the rotary cage storage device and the internal gripping mechanism of the present invention.

FIG. 10 is a partially enlarged schematic diagram of part A in FIG. 9.

FIG. 11 is a schematic diagram of the structure of the internal gripping mechanism of the present invention.

FIG. 12 is a partial enlarged schematic diagram of part B in FIG. 11.

### DETAILED DESCRIPTION OF THE EMBODIMENTS

The embodiments of the present invention will be described in detail below. Examples of the embodiments are shown in the accompanying drawings, wherein the same or similar reference numerals represent the same or similar elements or elements with the same or similar functions. The embodiments described below with reference to the accompanying drawings are exemplary, and are intended to explain the present invention, but should not be construed as limiting the present invention.

In the description of the present invention, it should be understood that the orientation or positional relationship indicated by the terms, such as “upper”, “lower”, “front”, “rear”, “left”, “right”, “vertical”, “horizontal”, “top”, “bottom”, “inner”, “outer”, etc. is based on the orientation or positional relationship shown in the drawings, and it is only for the convenience of describing the present invention and simplifying the description, rather than indicates or implies the pointed device or the element must have a specific orientation or be constructed and operated in a specific orientation, and therefore it cannot be understood as a limitation of the present invention.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the present invention, “several” means two or more than two, unless specifically defined otherwise.

In the present invention, unless otherwise clearly specified and limited, the terms “install”, “connect”, “link”, “fix” and other terms should be interpreted expansively. For example, it can be a fixed connection or a detachable connection, or integrated; it can be a mechanical connection or an electrical connection; it can be directly connected or indirectly connected through an intermediate medium, or it can be the internal communication or the interaction relationship of two elements. For those of ordinary skill in the field, the specific meaning of the above-mentioned terms in the present invention can be understood according to specific circumstances.

In the present invention, unless otherwise clearly defined and defined, the situation that the first feature is “above” or “below” the second feature may include the first and second features are in direct contact or in indirectly contact through other features between them. Moreover, the situation that the first feature is “above”, “over” and “upper” the second feature may include the first feature is directly above and obliquely above the second feature, or it simply means that the level of the first feature is higher than the second feature. The situation that the first feature is “below”, “under” and “lower” the second feature may include the first feature is directly below and obliquely below the second feature, or it simply means that the level of the first feature is smaller than the second feature.

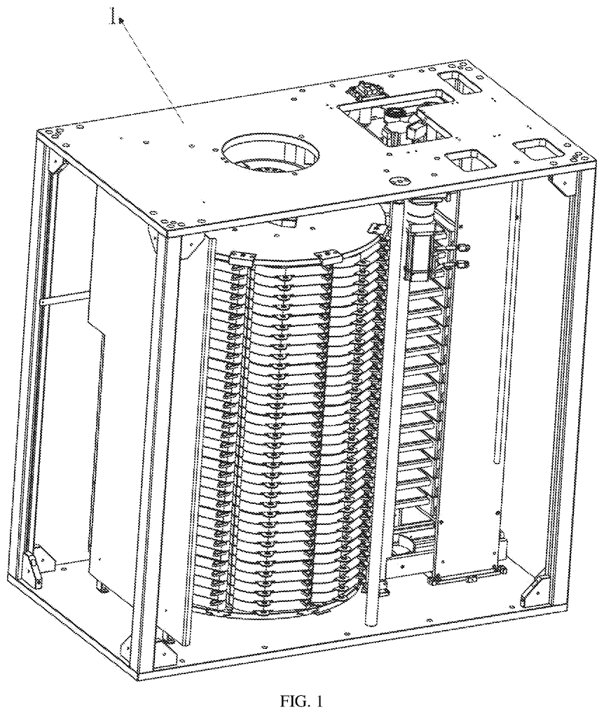

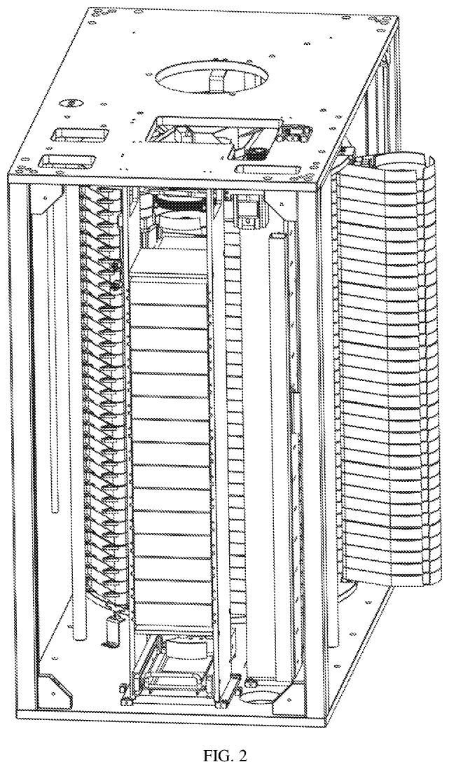

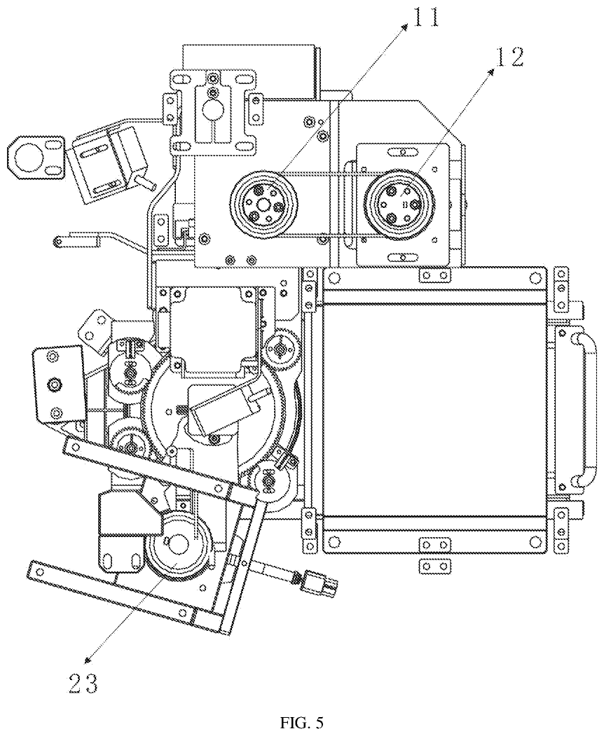

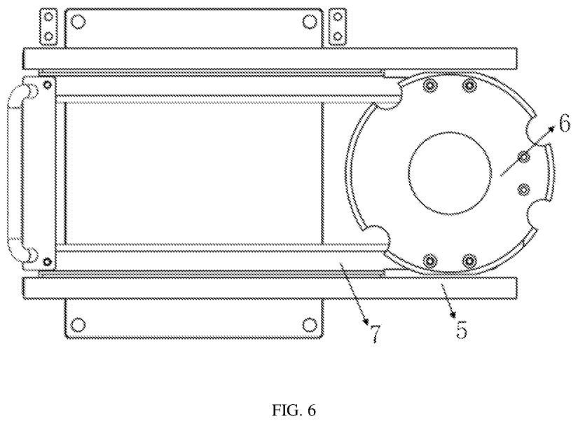

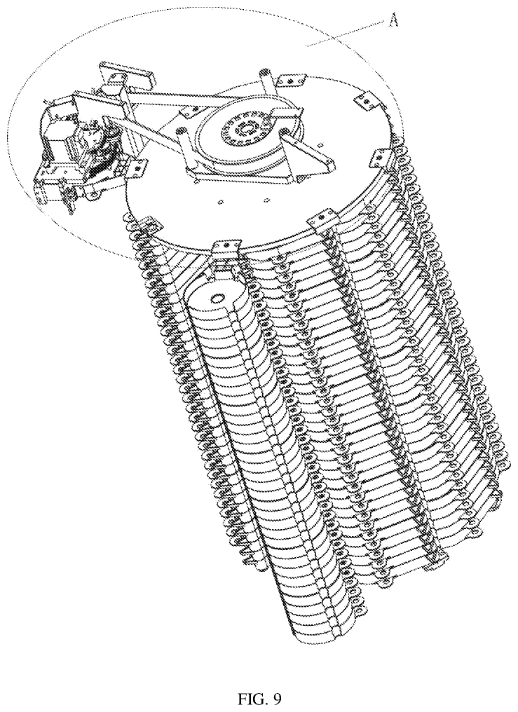

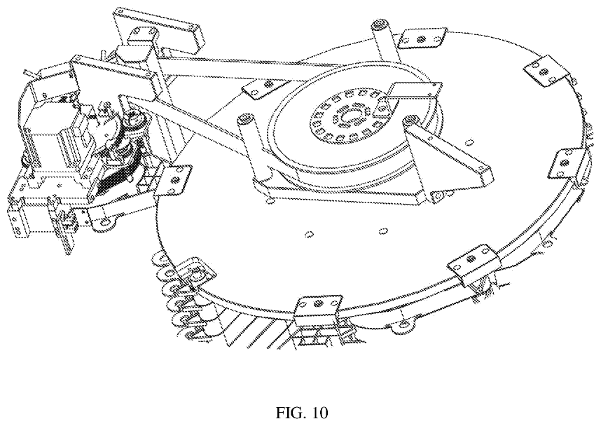

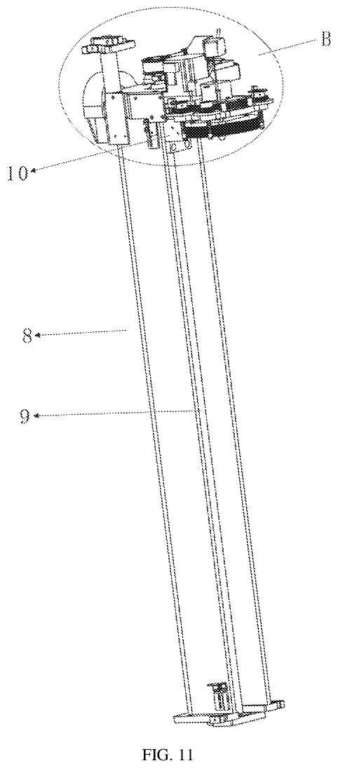

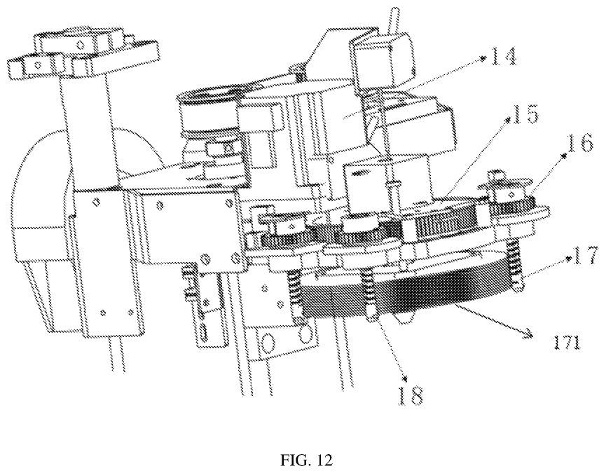

The following describes in detail a rotary cage type optical disk library storage system capable of replacing optical disks according to an embodiment of the present invention according to FIGS. 1-12.

Referring to FIG. 1, the embodiment of the present invention discloses a rotary cage type optical disk library storage system capable of replacing optical disks. The device includes a case 1, a burning device and a rotary cage storage device 19.

The burning device fixed in the case 1 includes a burn cabinet 2, a disk feeding mechanism 4 and an internal gripping mechanism 8.

As shown in FIGS. 1-4, multiple optical disk cartridges 3 are arranged from top to bottom in the burning cabinet 2. The optical disk cartridges 3 can be automatically ejected and rebounded, and the optical disk cartridges 3 are located just below the internal gripping mechanism 8 after ejecting.

As shown in FIGS. 1-2 and FIG. 6, the disk feeding mechanism 4 located directly below the burning cabinet 2 includes the chute 5 provided at the bottom of the case 1 and the optical disk tray 6 slidably connected to the chute 5. The optical disk is placed in the optical disk tray 6. The bottom of the optical disk tray 6 is provided with a sliding rail 7 cooperating with the chute 5 to slide. The optical disk tray 6 can slide just below the internal gripping mechanism 8 under pushing.

The internal gripping mechanism 8 can move up and down and grab and place the optical disk.

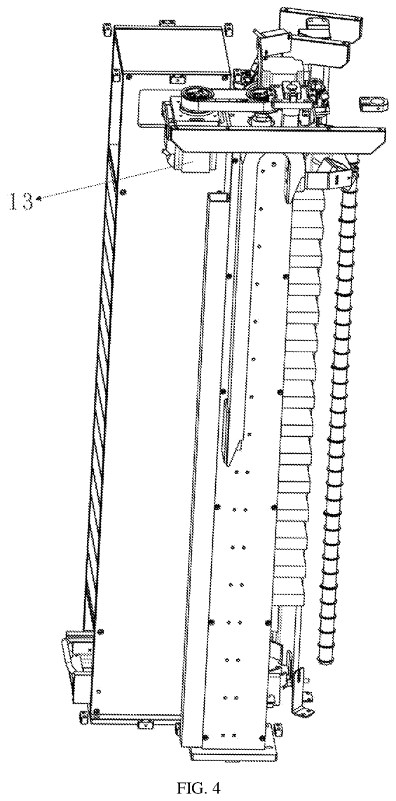

Specifically, as shown in FIGS. 4, 5, 11 and 12, a screw lever 9 is fixed in the case 1 in vertical direction, and the top end of the screw lever 9 is fixed with a driven wheel 11. The driven wheel 11 is connected with a driving wheel 12 through a belt, and the driving wheel 12 is driven to rotate by a driving wheel motor 13. The internal gripping mechanism 8 is provided with a slider 10 matched with the screw lever 9, and the screw lever 9 rotates to drive the slider 10 and the internal gripping mechanism 8 to move up and down.

The internal gripping mechanism 8 also includes an internal gripper motor 14, and a large gear 15 is connected to the lower output shaft of the internal gripper motor 14. The large gear 15 is fitted and engaged with several small gears 16 around. An optical disk clamping lever 17 is installed at the bottom of each small gear 16. The diameter of the inner ring enclosed by the several optical disk clamping levers 17 is slightly larger than the outer diameter of the optical disk. A horizontally convex optical disk baffle 18 is provided at the lower part of the optical disk clamping lever 17.

The internal gripper motor 14 controls the rotation angle of the optical disk clamping lever 17 to realize the grasping and placing of the optical disk. Multiple optical disk clamping levers 17 are the grippers of the optical disk. When a grabbing of the optical disk is desired, the optical disk clamping levers 17 are firstly inserted around the optical disk, and then the internal gripper motor 14 controls the rotation of the large gear 15, and the large gear 15 drives several small gears 16 to rotate, and the optical disk clamping lever 17 on the small gears 16 rotate accordingly. So that the optical disk baffle 18 is screwed against the bottom surface of the optical disk and the optical disk would not fall down, thus the purpose of grabbing the optical disk is achieved. When a placing of the optical disk is desired, the optical disk clamping lever 17 is controlled to rotate to allow the optical disk baffle 18 rotating outward, and the optical disk falls into the corresponding position.

As shown in FIGS. 1-3, the rotary cage storage device 19 and the burning device are fixed in the case 1 side by side. The rotary cage storage device 19 includes a rotary cage mechanism 20, a rotary cage cassette 21 provided in the rotary cage mechanism 20 for storing optical disks, and a belt drive mechanism 22 driving the rotary cage mechanism 20 to rotate.

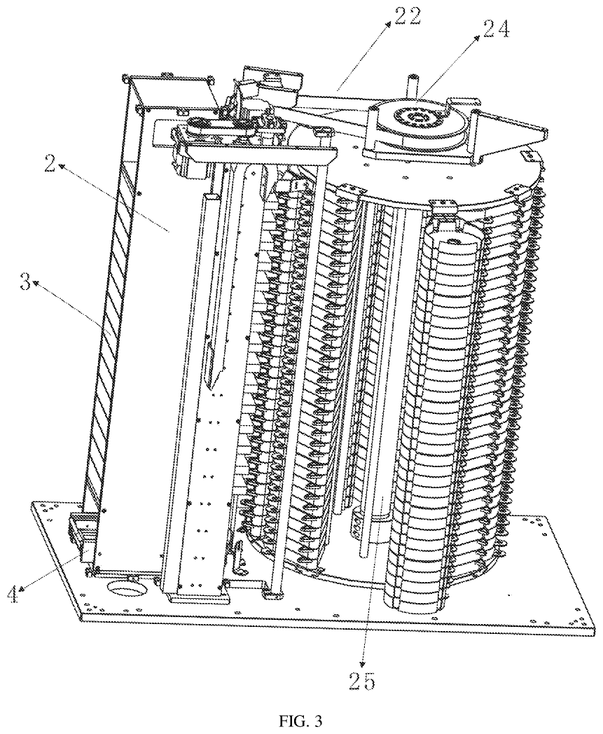

As shown in FIG. 3, the belt drive mechanism 22 includes a belt motor, a small pulley 23 driven to rotate by the belt motor, and a large pulley 24 connected to the small pulley 23 through a belt. The case 1 is connected with a central shaft 25 of rotary cage in the vertical direction in the case 1. The central shaft 25 of rotary cage is fixed on the central shaft of the rotary cage mechanism 20 and the top end of the central shaft 25 is fixed with the large pulley 24.

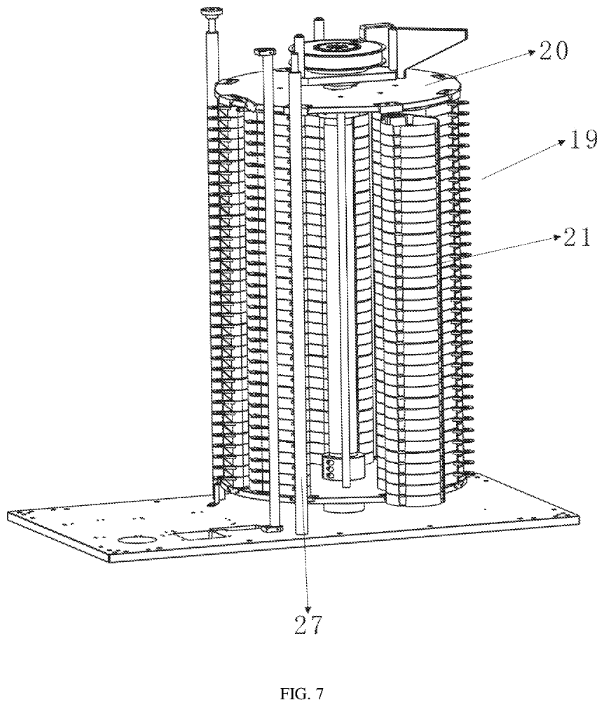

As shown in FIGS. 7, 9 and 10, the rotary cage cassette 21 is stacked and installed in layers with the central shaft 25 being the center. The rotary cage cassette 21 can be rotated outward and inward relative to the rotary cage mechanism 20, and the rotary cage cassette 21 is located just below the internal gripping mechanism 8 after being rotated outward.

The rotary cage cassette 21 is evenly distributed on the circumference of the central shaft 25 of rotary cage, which greatly increases the capacity of the optical disk. The rotary cage cassette 21 can realize its own rotation around the cassette positioning axis located in the rotary cage mechanism 20. The belt drive mechanism 22 drives the central shaft 25 to rotate, and the rotary cage mechanism 20 can drive the rotary cage cassette 21 inside to rotate outward to just below the internal gripping mechanism 8 and rotate inward.

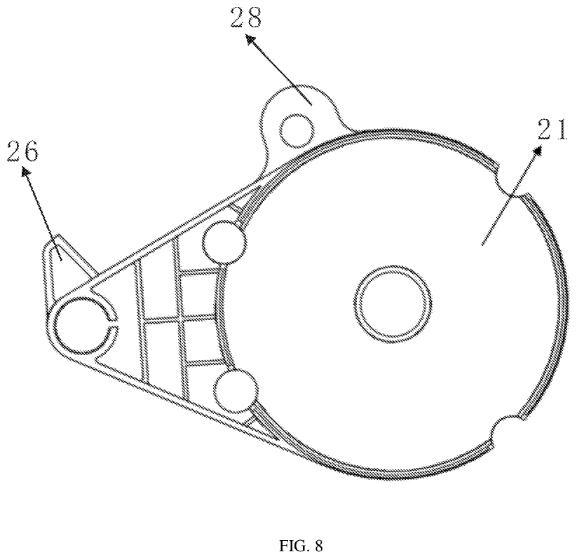

Specifically, as shown in FIG. 8, each rotary cage cassette 21 is provided with a positioning piece 26 for the rotation and positioning of the cassette. The internal gripping mechanism 8 is provided with a rotating paddle. When the rotary cage mechanism 20 makes a circular motion, the rotating paddle and the positioning piece 26 can be in contact match with each other. Under the action of force, the rotating paddle drives the rotary cage cassette 21 to rotate outwards to just below the internal gripping mechanism 8, and the unscrewing process of the rotary cage cassette 21 is completed. The case 1 is also provided with a return lever 27. The rotary cage cassette 21 is provided with a return gear ring 28. When the rotary cage mechanism 20 rotates in a circular motion, the rotary cage cassette 21 returns to an initial position through the relative movement between the return lever 27 and the return gear ring 28.

Specific working processes of the present invention are as below.

The optical disk that has not been burned into the optical disk tray 6 is placed, and through mutual movement of the sliding rail 7 and the chute 5, the optical disk that has not been burned moves to below the internal gripping mechanism 8 along with the optical disk tray 6.

The driving wheel motor 13 is used to control the internal gripping mechanism 8 to move up and down, and the internal gripper motor 14 is used to control the rotation angle of the optical disk clamping lever 17. So that the grasping and placing of the optical disk by the optical disk clamping lever 17 is realized. The driving wheel motor 13 and the internal gripper motor 14 cooperates to put the optical disk that has not been burned into the optical disk cartridge 3 of the burn cabinet 2 for the automatic burning process.

The burned optical disk is then ejected from the burn cabinet 2. When the internal gripping mechanism 8 grabs the burned optical disk and moves to be parallel to the uppermost rotary cage cassette 21, the belt drive mechanism 22 starts to drive the rotary cage mechanism 20, then the rotary cage mechanism 20 begins to drive the rotary cage cassette 21 to rotate. The rotary cage cassette 21 is provided with positioning piece 26 for its rotation and positioning. During the rotation, the positioning piece 26 and rotating paddle on the internal gripping mechanism 8 are in contact with each other, and the rotary cage cassette 21 begins to rotate around the cassette positioning axis, and finally the uppermost rotary cage cassette 21 is unscrewed. At this time, the belt drive mechanism 22 stops working, and the internal gripping mechanism 8 places burned optical disk into the rotary cage cassette 21.

The belt drive mechanism 22 restarts to drive the rotary cage mechanism 20 and the rotary cage cassette 21 to rotate back. The case 1 is also provided with a return lever 27. During the rotating back process, the return gear ring 28 comprised rotary cage cassette 21 contacts with the return lever 27. At this time, the rotary cage mechanism 20 continues to rotate, and the rotary cage cassette 21 rotates into the rotary cage mechanism 20 under the action of force to complete the return.

The above actions are repeated until all the burned optical disks are placed in the rotary cage cassette 21 in the rotary cage storage device 19.

The various embodiments in this specification are described in a progressive manner. Each embodiment focuses on the differences from other embodiments, and the same or similar parts among the various embodiments can be referred to each other. For the device disclosed in the embodiment, since it corresponds to the method disclosed in the embodiment, the description is relatively simple, and the relevant part can be referred to the description of the method part.

The above description of the disclosed embodiments enables those skilled in the art to implement or use the present invention. Various modifications to these embodiments will be obvious to those skilled in the art, and the general principles defined herein can be implemented in other embodiments without departing from the spirit or scope of the present invention. Therefore, the present invention will not be limited to the embodiments shown in this document, but should conform to the widest scope consistent with the principles and novel features disclosed in this document.

1. A rotary cage type optical disk library storage system capable of replacing optical disks, comprising a case, a burning device and a rotary cage storage device;
wherein the burning device is fixed in the case; the burning device comprises a burn cabinet, a disk feeding mechanism, and an internal gripping mechanism; a plurality of optical disk cartridges are arranged in layers from top to bottom in the burning cabinet; the plurality of optical disk cartridges are configured to be automatically ejected and rebounded; the optical disk cartridge is located just below the internal gripping mechanism after being ejected; the disk feeding mechanism located just below the burning cabinet comprises a chute provided at the bottom of the case and an optical disk tray slidably connected with the chute; the optical disk is placed in the optical disk tray; the optical disk tray is configured to slide just below the internal gripping mechanism under pushing; the internal gripping mechanism is configured to move up and down and grab and place the optical disk;
the rotary cage storage device and the burning device are fixed side by side in the case; the rotary cage storage device comprises a rotary cage mechanism, a rotary cage cassette provided in the rotary cage mechanism for storing optical disks, and a belt drive mechanism driving the rotary cage mechanism to rotate; the rotary cage cassette is stacked and installed in layers with a central shaft of the center of the rotary cage mechanism; and the rotary cage cassette is configured to be rotated outward and inward relative to the rotary cage mechanism, and the rotary cage cassette is located just below the internal gripping mechanism after being rotated outward;
a screw lever is fixed in the case in a vertical direction, and a top end of the screw lever is fixed with a driven wheel; the driven wheel is connected with a driving wheel through a belt; the driving wheel is driven to rotate by a driving wheel motor; the internal gripping mechanism is provided with a slider matched with the screw lever, and the screw lever rotates to drive the slider and the internal gripping mechanism to move up and down;
the internal gripping mechanism further comprises an internal gripper motor; a large gear is connected to a lower output shaft of the internal gripper motor; and a plurality of small gears are meshed around the large gear; a plurality of optical disk clamping levers are installed at the bottom of each small gear; a diameter of an inner ring enclosed by the plurality of optical disk clamping levers is slightly larger than an outer diameter of the optical disk; and a horizontally convex optical disk baffle is provided at the lower part of the plurality of optical disk clamping levers.

2. The storage system of claim 1, wherein a bottom of the optical disk tray is provided with a sliding rail cooperating with the chute to slide.

3-4. (canceled)

5. The storage system of claim 1, wherein the belt drive mechanism comprises a belt motor, a small pulley driven to rotate by the belt motor, and a large pulley connected to the small pulley through a belt; the central shaft is rotationally connected with the case in the vertical direction of the case; and the central shaft of rotary cage mechanism is fixed on the central axis of the rotary cage mechanism and a top end of the central shaft is fixed with the large pulley.

6. The storage system of claim 5, wherein the central shaft is connected with the case through a bearing.

7. The storage system of claim 6, wherein the rotary cage cassette is stacked and installed in layers with the central shaft of rotary cage mechanism as the center, and is configured to rotate around the cassette positioning axis in the rotary cage mechanism; the central shaft of rotary cage mechanism drives the rotary cage mechanism to rotate; the rotary cage mechanism is configured to drive the rotary cage cassette inside to rotate outward to just below the internal gripping mechanism and rotate inward.

8. The library storage system of claim 7, wherein each rotary cage cassette is provided with a positioning piece for the rotation and positioning of the cassette; the case is further provided with a return lever; the rotary cage cassette is provided with a return gear ring; when the rotary cage mechanism rotates in a circular motion, the rotary cage cassette returns to an initial position by a relative movement between the return lever and the return gear ring.
